(19) United States
(12) Patent Application Publication
(10) Pub. No.: US 2008/0044121 A1
(43) Pub. Date: Feb. 21, 2008

(54) Tapered Roller Bearing for a Wheel

(75) Inventors: Heinrich Hofmann, Schweinfurt (DE); Johannes Boer, Uchtelhausen (DE); Horst Doppling, Herzogenaurach (DE); Bernhard Wilm, Nudlingen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/569,701

(22) PCT Filed: May 21, 2005
(86) PCT No.: PCT/DE05/00937

§ 371 Date: Jul. 12, 2007

(30) Foreign Application Priority Data
May 29, 2004 (DE) 10 2004 026 457.0

(51) Int. Cl. F16C 33/58

(52) U.S. Cl. 384/571

(57) ABSTRACT

The invention relates to a wheel bearing unit comprising at least one inner raceway for tapered rollers and an axial support for front faces of the tapered rollers that is joined to the inner raceway. The axial support is axially joined to the tapered rollers on the side of the large diameter of the tapered rollers, and the axial support radially projects above the largest inside diameter of the inner raceway.

### FIELD OF THE INVENTION

A wheel bearing unit of this type is described in U.S. Pat. No. 5,037,214. This wheel bearing unit was provided in order to simplify production and to standardize the installation of the individual parts.

Wheel bearings usually have at least one but generally two or more inner raceways for tapered rollers directly on a wheel carrier or on one or more outer rings. The outer ring or the outer rings are accommodated in a wheel carrier. The wheel carrier is provided with one or more flanges. A flange is generally used for the vehicle-side fastening of the wheel carrier or for the fastening of one or more vehicle wheels to the wheel carrier. In the last-mentioned case, the hub is fastened on the vehicle side and the inner raceways rotate about the fixed hub. If the wheel carrier is fixed on the vehicle side, the hub is mounted rotatably in the wheel carrier by means of the wheel bearing, as a result of which the outer raceways are mounted rotatably in relation to the inner raceways which are fixed on the vehicle side. In this case, one or more vehicle wheels is/are fastened to the hub.

It is known that angular roller bearings—in particular tapered roller bearings, on account of the contact angle predetermined by the construction, are capable of absorbing forces or components of forces via the raceways that are acting radially with respect to the axis of rotation as well as axially acting forces, i.e. forces that are acting in the same direction as the axis of rotation of the wheel bearing. However, in addition, axial supports preventing the axial migration of the rollers out of the raceways have to be provided for the flanks of the rollers. These axial supports are usually inner-ring restraining flanges which protrude over the raceways of the inner rings of the wheel bearing and on which the front faces of the tapered rollers run.

With the wheel bearing according to U.S. Pat. No. 5,037,214, a wheel bearing was provided in which at least one of the axial supports is fastened to the outer ring in the form of a supporting ring that is separate from the outer ring. These axial supports are adjoined axially to the tapered rollers at the inner raceway on the side of the largest diameter of the tapered rollers. The axial support radially projects above the largest inside diameter of the respective inner raceway adjoined by the axial support. Consequently, the installation of the bearing is initially simplified. However, this solution is unsatisfactory in particular for bearings in which high axial forces act. In this case, as described in U.S. Pat. No. 5,037,214, the ring is securely held in position against the forces only by means of a weld seam. The heat introduced into the bearing by the welding operation can, on the one hand, negatively influence the functionally induced axial stress in the bearing, particularly since said axial stress can no longer be corrected since the ring is fastened nonreleasably by means of welding. On the other hand, the heat from the welding operation damages the grease in the bearing and also has an effect, due to heat distortion, on the precision of the arrangement. Irrespective thereof, the installation of the wheel bearing module comprising individual parts is still relatively costly.

### SUMMARY

It is therefore the object of the invention to provide a wheel bearing unit which is robust, the inner and outer raceways of which can be produced cost-effectively and the individual parts of which can be fitted in a simple manner.

This object is achieved in that the particular axial support assigned to an inner raceway is a restraining flange formed integrally with the inner raceway. If the inner raceway(s) is/are arranged directly on the wheel carrier, the restraining flange or the restraining flanges are accordingly formed integrally with and of the same material as the wheel carrier. The inner raceway(s) is/are preferably formed on an outer ring which is fitted into the wheel carrier. In this case, a respective restraining flange is assigned to each of the inner raceways, the inner raceways preferably running axially between the restraining flanges, i.e. the large front faces of the one row of tapered rollers face away from the large front faces of the axially adjacent row of tapered rollers.

The inner rings do not have a restraining flange and are therefore simpler to machine. The constructional unit is simple to fit. The number of individual parts and therefore the complexity of installation are reduced.

One embodiment of the invention provides the wheel bearing as a constructional unit which, entirely preassembled with one or two inner rings and with or without a hub, can be fitted into a wheel carrier. For this purpose, the wheel bearing has, per inner ring, at least one axial securing means which is operatively connected to the respective inner ring. For this purpose, the axial securing means axially adjoins the tapered rollers on the side of the smallest diameter of the tapered rollers and is in form-fit engagement with the inner ring. The axial securing means radially projects on the inner ring above the smallest diameter of the respective outer raceway and is thus axially opposite the front faces of the tapered roller on the side of the smallest diameter of the tapered rollers.

The wheel bearing can be transported and handled in a preassembled state, since the axial securing means holds the tapered rollers and the inner and outer rings together by means of contact with the small front faces of the tapered rollers. Alternatively to this, the axial securing means holds the unit together by axial contact with a cage, in which the tapered rollers are guided, instead of direct contact with the front sides. In this case, the simplest form of axial securing means is a securing ring which engages in a ring groove on the inner ring.

A further embodiment of the invention provides for the axial securing means to be formed directly on a cage for the tapered rollers. In this case, the axial securing means engages from the cage in a ring groove of the inner ring in a form-fitting manner. An axial securing means of this type is, for example, one or preferably a plurality of plastic snap-on lugs which are arranged on the circumference of the cage and, when the cage with the rolling bodies is slid onto the inner ring, give, and then spring into a corresponding ring groove on the inner ring.

### DESCRIPTION OF THE DRAWINGS

FIG. 1 shows a wheel bearing unit 1, preferably two wheel bearing units 1 of which are installed, positioned opposite each other, in a wheel carrier (not illustrated). The wheel bearing unit 1 has an inner ring 2 with an outer raceway 3 and an outer ring 4 with an inner raceway 5. Tapered rollers 6 which run along the inner raceway 5 and the outer raceway 3 are arranged between the inner ring 2 and the outer ring 4. The tapered rollers 6 are guided in a cage 9. The outer ring 4 has a restraining flange 7 which is formed integrally with the outer ring 4 and therefore integrally with the inner raceway 5. The restraining flange 7 radially projects above the inner raceway 5 in the direction of the axis of rotation 1a on the side of the largest inside diameter Dᵢ and therefore lies opposite the largest front face 6a of the tapered roller 6 on the side of the large diameter of the tapered rollers 6. The wheel bearing unit 1 is held by means of the axial securing means 8 in the form of a plurality of snap-on lugs 9a formed integrally with the cage 9. The snap-on lug 9a is formed on that side of the cage 9 which adjoins the small diameter of the tapered rollers 6. The axial securing means 8 engages in a form-fitting manner in a groove 2b of the inner ring 2 that adjoins the outer raceway 3 at its smallest outside diameter Dₐ. The outer ring 4 has, on the outside, a cylindrical circumferential surface 4a which is provided for the seat in the wheel carrier (not illustrated). The inner ring 2 is provided with an inner circumferential surface 2a for the seat on a hub (not illustrated).

FIG. 2 shows a wheel bearing unit 10 with two rows of tapered rollers 6 positioned opposite each other. In the fitted state, the tapered rollers 6, which are each guided in a cage 11, are prestressed against a common outer ring 13 by means of the inner rings. The prestressing takes place as rule on a hub (not Illustrated) on which the inner rings 12 sit by means of the inner circumferential surface 12a. Each of the inner rings 12 has a respective outer raceway 3 and the outer ring 13 has two inner raceways 5. Tapered rollers 6 which run along the inner raceway 5 and along the outer raceway 3 are arranged between the inner ring 12 and the outer ring 13. The outer ring 13 has two of the restraining flanges 7, each of which is formed integrally with the outer ring 13 and therefore integrally with the particular inner raceway 5. Each of the restraining flanges 7 radially projects above the inner raceway 5 in the direction of the axis of rotation 10a on the side of the largest inside diameter Dᵢ and therefore lies opposite the largest front face 6a of the tapered roller 6 on the side of the large diameter of the tapered rollers 6. The wheel bearing unit 10 is held by means of the axial securing means 8 in the form of securing rings 14. Each of the axial securing means 8 sits in a form-fitting manner in a groove 12b of the particular inner ring 12. The grooves 12b adjoin the particular outer raceway 3 at its smallest outside diameter Dₐ. The outer ring 13 has, on the outside, a cylindrical circumferential surface 13a which is provided for the seat in the wheel carrier (not illustrated).

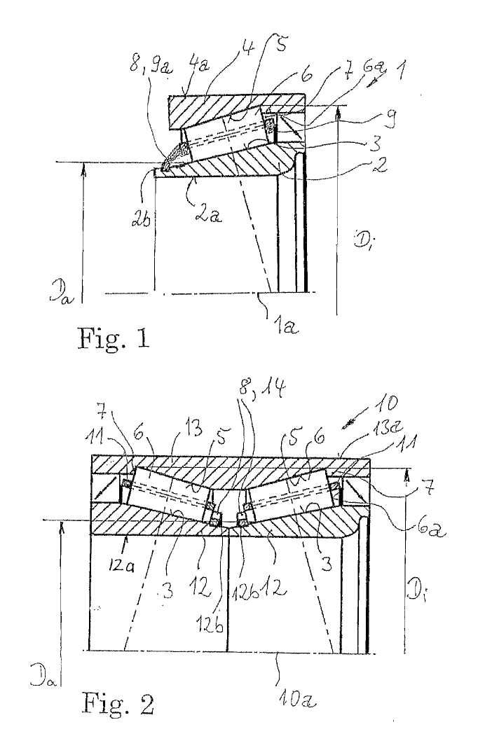

### REFERENCE NUMBERS

1 wheel bearing unit
1a axis of rotation
2 inner ring
2a inner circumferential surface
2b groove
3 outer raceway
4 outer ring
4a outer circumferential surface
5 inner raceway
6 tapered roller
6a front face
7 restraining flange
8 axial securing means
9 cage
9a snap-on lug
10 wheel bearing unit
10a axis of rotation
11 cage
12 inner ring
12a inner circumferential surface
12b groove
13 outer ring
13a circumferential surface
14 securing ring

1. A wheel bearing unit comprising: at least one inner raceway for tapered rollers and an axial support for front faces of the tapered rollers that adjoins the inner raceway, the axial support axially adjoining the tapered rollers on the side of the large diameter of the tapered rollers, and the axial support radially projecting above the largest inside diameter of the inner raceway, wherein the axial support is a restraining flange formed integrally with the inner raceway.

2. The wheel bearing unit of claim 1, wherein the wheel bearing unit has two of the inner raceways and a respective restraining flange on each of the inner raceways.

3. The wheel bearing unit of claim 2, wherein the inner raceways run axially between the restraining flanges.

4. The wheel bearing unit of claim 1, wherein the inner raceway and the restraining flange are formed integrally with an outer ring of the wheel bearing unit.

5. The wheel bearing unit of claim 1, wherein the wheel bearing unit has at least one inner ring and an axial securing means, the axial securing means axially adjoining the tapered rollers on the side of the small diameter of the tapered rollers, and the axial securing means and the inner ring being in a form-fitting operative connection.

6. The wheel bearing unit of claim 5, wherein the axial securing means is fastened to the inner ring, the axial securing means at least radially projecting above the smallest outside diameter of an outer raceway of the inner ring.

7. The wheel bearing unit of claim 6, wherein the wheel bearing unit has a cage for the tapered rollers, the axial securing means at least partially axially lying opposite the cage.

8. The wheel bearing unit of claim 5, wherein the wheel bearing unit has a cage for the tapered rollers, the axial securing means being formed on the cage and the axial securing means engaging in a ring groove of the inner ring.

9. The wheel bearing unit of claim 1, wherein the wheel bearing unit has two rows of tapered rollers, two of the inner rings and two of the axial securing means, the axial securing means being arranged axially next to each other between the rows.
